(19) United States
(12) Patent Application Publication
(10) Pub. No.: US 2012/0112923 A1
(43) Pub. Date: May 10, 2012

(54) Back looking warning assembly and a method for determining the presence of a tangible entity in close proximity to the back of an individual

(76) Inventor: John Gerard Chupa, Farmington Hills, MI (US)

(21) Appl. No.: 13/199,971

(22) Filed: Sep. 14, 2011

Related U.S. Application Data
(63) Continuation-in-part of application No. 12/927,072, filed on Nov. 5, 2010.

(51) Int. Cl. G08B 21/00; G08B 5/22; H04W 4/02

(52) U.S. Cl. 340/686.1; 455/404.2; 340/8.1

(57) ABSTRACT

A portable assembly 10 which may be selectively worn on the body of a user 14 and which detects the presence of a tangible entity 80 which is located behind or at any other location or portions of the user 14. Multiple assemblies 10 may be utilized. The assembly may include a message generation portion 500 and a location portion 510.

### GENERAL BACKGROUND

1. Field Of The Invention

The present invention generally relates to a back looking warning assembly and to a method for determining the presence of a tangible entity in close proximity to the back (or other portion) of an individual and more particularly, to an assembly and to a method for allowing a walker, hiker, and/or runner (or any individual) to be warned when a person, animal, or other tangible entity approaches the back (or other portion) of the user, thereby preventing or reducing the likelihood of an undesired surprise.

2. Background of the Invention

People have become much more health conscious and accordingly many people enjoy running, jogging, hiking, running, or otherwise moving in order to exercise and improve their respective overall health. While these activities are desirable, they are not without risk.

That is, unfortunately in this society many of these exercisers (and other individuals) are accosted by people who “sneak up” from behind these individuals and rob them, injure them, and/or kidnap them. This is particularly true when one considers that many of these exercisers need to run or otherwise move in great distances in order to achieve their respective and desired level of activity. This means that many of these individuals, at least part of the time, traverse rather sparsely populated and somewhat heavily forested or remote areas, thereby increasing the probability that someone may be able to “sneak up from behind them” and accost them without being noticed and without the availability of help or assistance for the exerciser. Moreover, many of these exercisers purposefully traverse a park or other forested and sparsely populated environment in order to “enjoy the scenery”, thereby further increasing the probability of being accosted, without warning. Further, many individuals perform these activities at dusk or in the early morning due to scheduling constraints and/or due to rather hot/humid weather occurring during the remainder of the day. This practice further and unfortunately increases the probability of the occurrence of such an undesirable occurrence. Further, many individuals employ a head phone arrangement, while running or otherwise exercising, thereby greatly reducing their respective ability to hear an individual (or other tangible entity) sneaking up from behind them. Further, it should be appreciated that both individuals as well as animals (e.g., bears) may sneak up from behind an exerciser and, without warning, accost them. Other tangible entities, such as cars or trucks, may similarly cause damage to an individual without warning.

There is therefore a need for a system and a method which warns an individual of the presence of a potentially threatening tangible entity (e.g., such as an individual or animal or vehicle) behind them or otherwise in close proximity to them and the present inventions provide such a system and a method.

### SUMMARY OF THE INVENTION

It is a first non-limiting object of the present invention to provide a method and an assembly which warns an individual of the presence of a potentially threatening tangible entity.

It is a second non-limiting object of the present invention to provide an assembly which provides a warning to an individual of the presence of a potentially threatening tangible entity which is disposed behind the individual.

It is a third non-limiting object of the present invention to provide a method which provides a warning to an individual of the presence of a potentially threatening tangible entity which is disposed behind (or proximate to another portion) the individual.

According to a first non-limiting aspect of the present invention, a backward looking warning assembly is provided.

According to a second non-limiting aspect of the present invention, a warning assembly is provided and includes a belt: and a sensor which is operatively deployed upon the belt and which generates a signal and which, by use of the generated signal, determines the presence of an individual in close proximity to the sensor.

According to a third non-limiting aspect of the present invention, a method for determining the presence of a tangible entity in close proximity to the back of an individual who is moving in a first direction is provided. Particularly, the method includes the steps of providing a sensor which generates an electrical signal; placing the sensor upon the body of the individual effective to allow the signal to be generated in a second direction which is opposite to the first direction and which impinges upon the tangible entity; and using the generated signal to determine the presence of the tangible entity.

According to a fourth non-limiting aspect of the present invention, a warning assembly is provided having a first portion which senses the presence of an entity and a second portion which provides a message to a remote location.

According to a fifth non-limiting aspect of the present invention a warming assembly is provided having a portion which senses the presence of an entity and a second portion which allows the location of the warning assembly to be quickly determined.

According to a sixth non-limiting aspect of the present invention a portable warning assembly is provided and comprises a first portion which senses the presence of a tangible entity; a second portion which automatically generates a message upon the sensed presence of the tangible entity; and a portion which allows the location of the assembly to be determined when the tangible entity is sensed.

According to a seventh non-limiting aspect of the present invention a warning assembly is provided and comprises a controller assembly operating under stored program control; a memory portion which is coupled to the controller assembly and which includes a message and a cellular telephone number; a modem assembly which is coupled to the controller assembly; a global positioning portion which receives a remote signal and which transmits, upon receipt of the signal, a certain location; and a signal generator which is coupled to the controller assembly and which senses the presence of a tangible entity and which communicates the sensed presence of the tangible entity to the controller assembly, whereby the controller assembly retrieves the message and the telephone number and which activates the modem effective to cause the message to be sent to a telephone having the telephone number and wherein the controller assembly further activates the global positioning portion effective to allow the location of the global positioning portion to be identified.

According to an eighth non-limiting aspect of the present invention a method for determining the location of assets is provided and includes the steps of placing a global positioning locator upon each asset; displaying a map of the environment in which the assets are deployed; remotely interrogating each of the respective global positioning locators, effective to obtain the respective location of each asset; and displaying upon the map, the respective locations of each of the assets.

These and other features, aspects, and advantages of the present inventions will become apparent from a reading of the detailed description of the preferred embodiment of the invention, including the subjoined claims, and by reference to the following drawings.

### BRIEF DESCRIPTION OF THE DRAWINGS

FIG. 1 is a perspective view of an individual wearing the assembly of the preferred embodiment of the invention being followed by a potentially threatening individual.

FIG. 2 is a front view of a belt incorporating the assembly which is shown in FIG. 1.

FIG. 3 is a block diagram of the assembly which is shown in FIGS. 1 and 2.

FIG. 4 is a side view of a belt which is made in accordance with the teachings of an alternate embodiment of the invention.

FIG. 5 is a right perspective view of an individual wearing the belt of FIG. 4.

FIG. 6 is a left perspective view of the individual shown in FIG. 5.

FIG. 7 are various signal signatures associates with the assembly of the invention.

FIG. 8 is a block diagram of alternate embodiment of the invention.

### DETAILED DESCRIPTION OF THE PREFERRED EMBODIMENT OF THE INVENTION

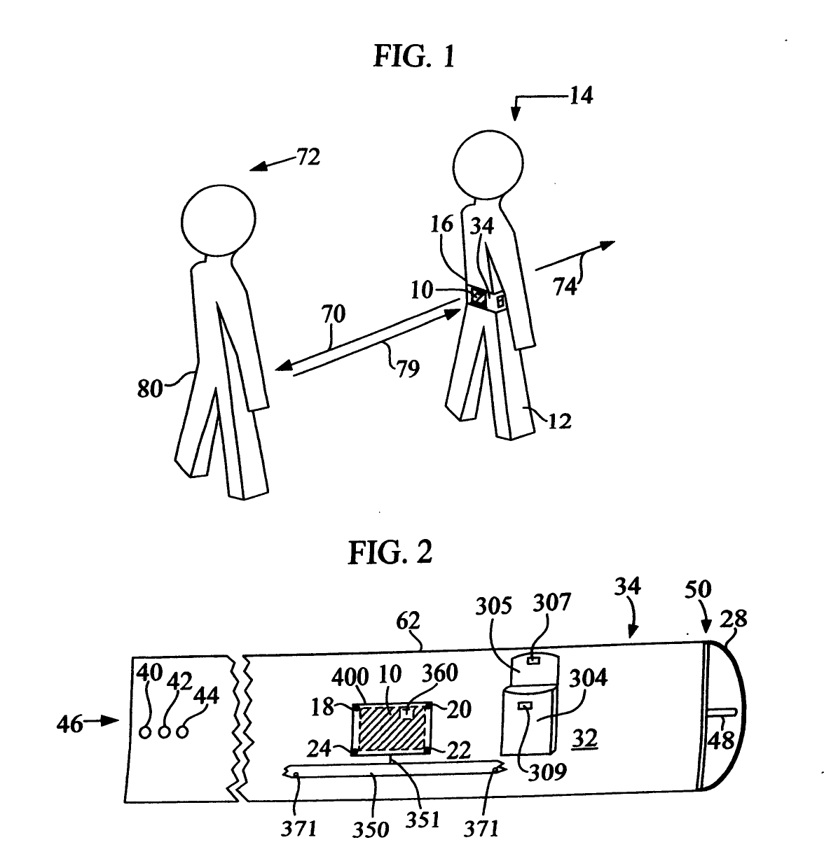

Referring now to FIGS. 1-6, there is shown a backward looking warning assembly 10 which is made in accordance with the teachings of the preferred embodiment of the inventions.

Particularly, assembly 10 is selectively and removably deployed upon the body 12 of an individual 14 (e.g., such as a runner, walker, jogger, hiker, or someone otherwise in motion). Typically, in one non-limiting embodiment the assembly 10 is selectively and removably deployed upon the lower back 16 of the user 14 and is lightweight, easily removable, and portable.

That is, in one non-limiting embodiment, the assembly 10 is fixedly attached (e.g., by the use of pins 18-24 which respectively penetrate through preformed holes in the casing 400 and attach casing 400 (and assembly 10) to the outside surface 32 of a belt 34. Other types of belts may be utilized. Moreover, the belt 34, in one non-limiting embodiment of the invention, is of the type having a plurality of openings 40, 42, 44 on a first end 46 and a selectively movable clasp 28 on the second opposed end 50. The clasp 28 has a selectively movable projection 48. The belt 34 may be deployed around the lower back or waist 16 of the user 14 such that the inside belt surface 62 lies directly upon the lower back or waist 16 of the user 14. The projection 48 is then selectively and removably inserted into one of the openings 40-44 to fixedly secure the belt 34 upon the lower waist or back 16. Alternatively the belt 34 may be entirely constructed of elastic (selectively stretchable and pliable) type material, thereby obviating the need for without the clasp 48 and the openings 40-44, and this elastic embodiment (such as an elastic band) may be readily and removably deployed upon the head or waist of the user 14.

The assembly 10 which may comprise one or more circuit boards which are operatively placed within the casing 400 (by fasteners)) is adapted to generate a signal 70, emanating in a direction 72 which is generally opposite to the general or relative direction 74 in which the user 14 is moving (e.g., the signal 70 moves away from the lower back or waist 16 of the user 14). Should a tangible entity 80 (e.g., a individual, animal, or inanimate object, such as a vehicle) approach the user 14 from behind the user's back or lower waist 60, the generated signal 70 impinges upon the tangible entity 80 and causes a reflected signal 79 to be transmitted to the assembly 10 along the general direction 74.Once the assembly 10 receives the reflected signal 79, an audio or visual or some other type of sensory alarm may be activated thereby notifying the user 14 of the presence of the tangible entity 80 behind the user 14 and allowing the user 14 to take some sort of countermeasure (e.g., begin to run away from the tangible entity 80). Alternatively or additionally to the audio and visual alarm, the assembly 10 may provide a vibrating output signal.

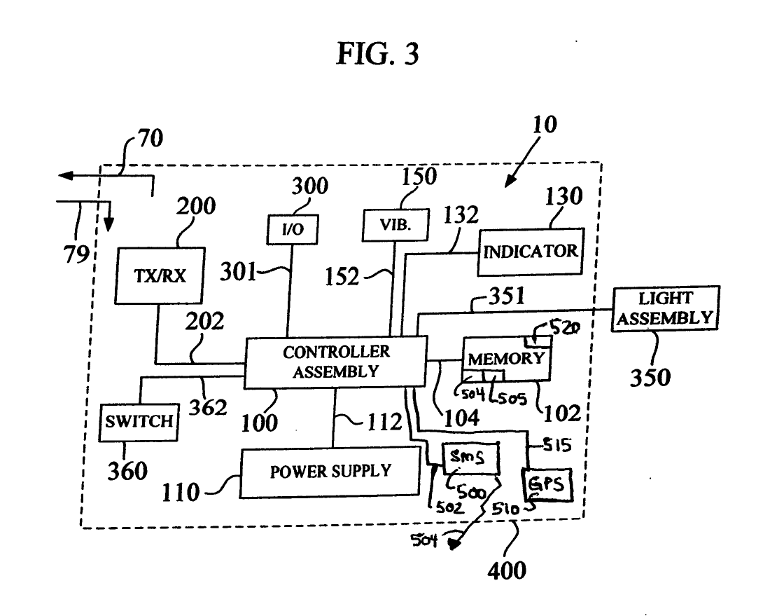

To understand the operation of the assembly 10, reference is now had to FIG. 3. As shown, the assembly 10, in one non-limiting embodiment, includes a controller assembly 100 which is operable under stored program control and which may comprise, in one non-limiting embodiment, a “dual-core” type of processor which is available from the Intel® Corporation. The assembly 10 further includes a memory assembly 102 which is coupled to the controller assembly 100 by the bus 104 and which contains the programming code necessary to define the operation of the assembly 10 and of the controller 100 and which further includes information which may be selectively written into and read from the memory assembly 102 by the controller assembly 100. The controller assembly 100 and the memory assembly 102 communicate by the use of the bus 104.

The assembly 10 further includes a source of electrical energy 110 which is coupled to the controller assembly 100 by the bus 112 and which provides operative electrical energy to the controller assembly 100 and to other portions of the assembly 10, through the controller assembly 100. In one non-limiting embodiment of the invention, the source 110 comprises a removable battery. Alternatively the source 100 may comprise a solar cell or substantially any other type of power source.

The assembly 10 further includes an indicator portion 130 which is coupled to the controller assembly 100 by use of the bus 132 and which, in one non-limiting embodiment, comprises a selectively energizable light and/or an audible alarm generator. The portion 130 receives energy from the provider 110 through the controller assembly 100 when the signal 79 is received by the assembly 10 (or when a signal 79 having a certain amplitude or strength is received) and upon receipt of the energy, the portion 130 provides a visual and/or audio and/or other type of sensory signal which alerts the user 14 to the undesired presence of the tangible entity 80. The assembly 10 may also include a vibrator 150 which is coupled to the controller assembly 100 by the use of the bus 152 and which receives electrical energy from the source 110 through the controller assembly 100 upon receipt of the signal 79 (or when a signal 79 having a certain amplitude or strength is received) by the assembly 10. In this manner, the vibrator 150 begins to vibrate and thereby notifies the user 14 of the undesired presence of the tangible entity 80 behind the user 14. The vibrator 150 may replace all or some of the portion 130 and provides a tactile indication of the sensed presence of the tangible entity 80. The vibrator 150 may also be used in combination with the indicator 130.

The assembly 10 includes a transmitter and receiver portion 200 which is coupled to the controller assembly 100 by the bus 202, and which receives operating energy from the provider 110 and the controller assembly 100, through busses 112, 202. The portion 200, upon a command from the controller assembly 100, generates the signal 70 and receives the signal 79. The received signal 79 is then communicated to the controller assembly 100 by use of the bus 202 and is recognized by the controller assembly 100 as having a certain amplitude or strength. It should be appreciated that a programmable signal strength factor may be deployed within the memory 102 and which is selectively readable by the controller assembly 100. This factor determines the strength or the amplitude of the signal 79 which is necessary for the controller assembly 100 to activate or selectively energize the vibrator 150 and/or indicator 130, by selectively allowing electrical energy to be respectively communicated to these components 150 and/or 130. For example, when the amplitude of the signal 79 is relatively high then the tangible entity 80 is relatively close to the user 14, and portions 130 and/or 150 are only activated in one non-limiting embodiment, when this condition occurs, thereby reducing false alarms or alarms due to tangible entities which are relatively far from the user 14.

This amplitude modification may be accomplished by a command which is generated to the controller assembly 100 through an input/output portion 300 which may form a portion of the assembly 10 and which is coupled to the controller assembly 100 through the use of bus 301. Thus, the user 14 may, be the use of portion 300 which may be selectively coupled to a computer, select or specify the amplitude of the signal 79 which is necessary to cause portions 130 and/or 150 to be selectively energized. The communicated amplitude is stored within memory 102 and rend y the assembly 100 when the assembly 100 receives a signal 79. Alternatively, each and every time a signal 79 is received, assembly 100 activates portions 130 and/or 150.

In one non-limiting embodiment of the invention, portion 200 may comprise an infrared or microwave alarm device or a programmable motion sensor such as those provided by the Guard Dog corporation and found, for example at www.guarddog.net. Portion 200 may comprise an acoustic sensor or any of the items discussed under the heading “motion detection” at the website www.wikipedia.org, or found on the website www.homesecuritystore.com, all of which is fully incorporated herein by reference.

Further, in various other non-limiting embodiments of the invention, the belt 34 may have at least one pocket 304 into which one or more items may be placed. The pocket 304 may have a selectively closable flap 305 which has a first Velcro® portion 307 which cooperates with a second Velcro® portion 309 to allow flap 305 to selectively close (prevent access to) and open (allow access in) the pocket 304. In yet another non-limiting embodiment, the assembly 10 may include a light assembly 350 (such as, by way of example and without limitation, a light emitting diode assembly) which is coupled to the controller assembly 100 by the bus 351 and which is operatively deployed (by the use of fasteners, such as pins) upon the surface 32 and which provides illumination light around and upon the surface 34 when a selectively depressible switch 360, which is coupled to the controller assembly 100 by bus 362 and which may form a portion of the assembly 10, is depressed, thereby providing light for the user 14. Switch 360 may be housed within the housing 400 which contains the various components of assembly 10. It should be appreciated that the belt 34 may be worn so that the assembly 10 is provided upon different positions along the waist of the user 14, thereby providing an indication of the presence of a tangible entity at respectively unique positions with respect to the user 14.

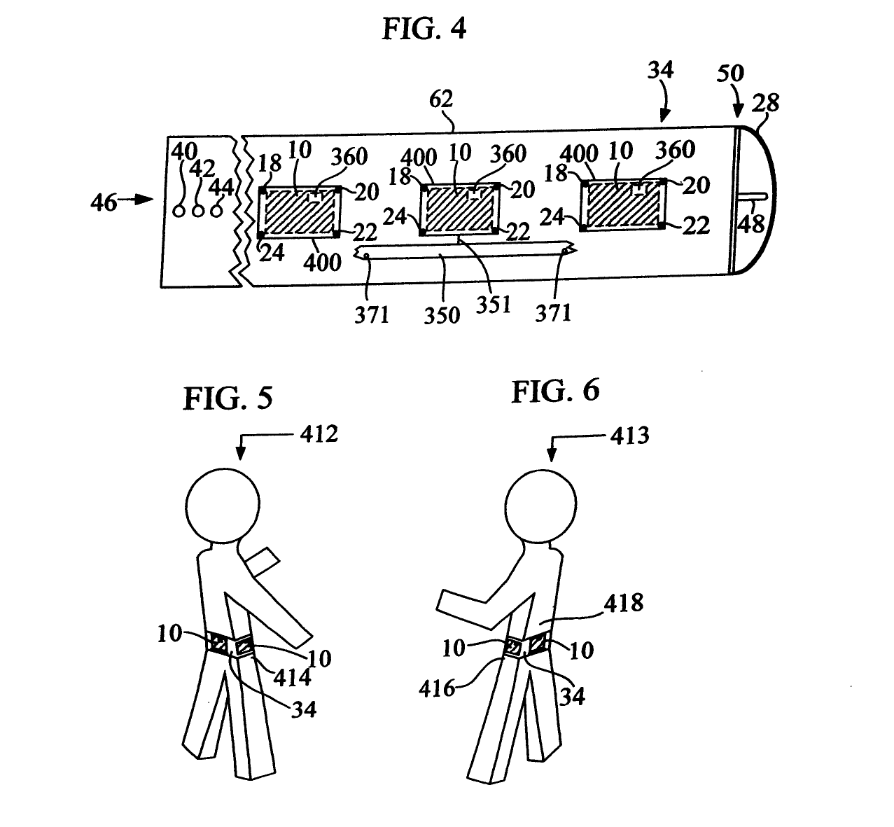

In yet another non-limiting embodiment, shown best in FIGS. 4-6, multiple assemblies 10 may be deployed upon the belt 34 such that when the modified belt 34 is worn by the user 412 an assembly is deployed upon the right hip 414, the left hip 416, and the back 418 of the user 412. Each assembly 10 respectively provides an indication of a tangible entity coming toward the user 412 from a respectively unique direction.

It is to be understood that the present inventions are not limited to the exact embodiment described above, but that various changes and modifications may be made without departing from the spirit and the scope of the inventions as they are further delineated in the following claims. It should be appreciated that the foregoing embodiments provide a portable and relatively lightweight strategy to protect an individual from the dangers emanating from tangible entities approaching the user in a multitude of diverse directions. Importantly, the assembly 10 is deployed upon an item, such as a belt 34, may be readily worn (deployed upon) an individual and as such is portable. That is, the assembly 10 “goes where the individual wherever and whenever the individual decides to move or whenever the individual resides (even when the individual is at rest). Thus, by having the assembly 10 deployed upon the individual the individual is “automatically” protected without the need to do more except to wear the belt 34 or whatever other article the assembly 10 is deployed upon. The assembly 10, including casing 400, may be removed from the belt 34 and just fastened or affixed to the user 14 by a strap, clip, or other fastener.

In yet another non-limiting embodiment of the invention, the assembly 10 includes an SMS or “short message service” assembly 500 which is coupled to the controller assembly 100 by use of the bus 502. In a non-limiting embodiment, the assembly 500 comprises a Quad Band GSM and GPRS Modem assembly (such as the WISM 2018 chip) and in this embodiment a previously configured text type cell phone or textual “short message” 504 is created and stored within the memory 102. The stored message is stored in combination with a targeted cellular telephone number 505. Upon the selective activation of the switch 360, the stored and previously configured message 504 is sent to the associated, previously stored, and previously designated cellular telephone. That is, the information 504, 505 is accessed by the controller assembly 100 and then transmitted to the assembly 500 by use of the bus 502. The controller assembly 100 may selectively activate the assembly 500 by allowing electrical power emanating from the power supply 110 to be communicated to the assembly 500. The assembly 500 then sends the message 504 to the identified member 505.Some non-limiting examples of the message 504 include “help”, although the message 504 could comprise any desired message of a “short length”. Moreover, the controller assembly 100 could, in yet another non-limiting embodiment, cause the message 504 to be automatically generated or “activated” when the vibrator 150 and/or indicator 130 is activated, or at any other time which is specified within the memory 102. In this manner, the user of the assembly 10 may send a message to a loved one or a friend or some other responsible party that a certain event has happened and some action may be required. The assembly 500 may be regarded as to “message generation” portion of the assembly 10 and selectively generates a message to a remotely located cellular telephone (e.g., “remote” from the assembly 10).

In yet a further non-limiting embodiment of the invention, the assembly 10 includes a real time GPS (Global Positioning System) tracker 510, such as that which is known as the “Spark Nano 2.0” which is offered by Brick House Security (www.BrickHouseSecurity.com). The tracker 510 is coupled to the controller assembly 100 by the bus 515 and allows someone, with access to the Internet to track “real time” location of assembly 10 and user/wearer of assembly 10. Electrical power is sourced to the assembly 510 by the controller assembly 100, by use of the power supply 110 and busses 112 and 515. In one non-limiting embodiment, electrical power is not supplied to the assembly 510 until the controller assembly 100 senses or determines that an alarm event has occurred or is occurring and/or that the message 504 has been transmitted from the assembly 10. Thus, in one non-limiting embodiment, a previously stored message 504 is sent to a previously designated cell phone and electrical power is selectively sourced to the assembly 510 (e.g., the assembly 510 is “activated”) so that the recipient of the message 504, by use of the Internet, may determine the location of the user of the assembly 10 and call someone for help for the user or take some other action. Of course, in yet another non-limiting embodiment, electrical power may be continually sourced to the assembly 510, thereby allowing someone to track, in “real time”, the location of the user of the assembly 10. Portions 500 (the message generation portion) and 510 (the location determination portion) may be used independently of each other, alternatively used, or concurrently used, depending upon the needs of the user of the assembly 10 and depending upon the operating specifications which are stored within the memory 102 and accessed by the controller assembly 100. In one non-limiting embodiment, the portion 510 sends the location information after receiving a query or an interrogation signal, although the portion 510 could be configured to send the location information as soon as the portion 510 is selectively activated.

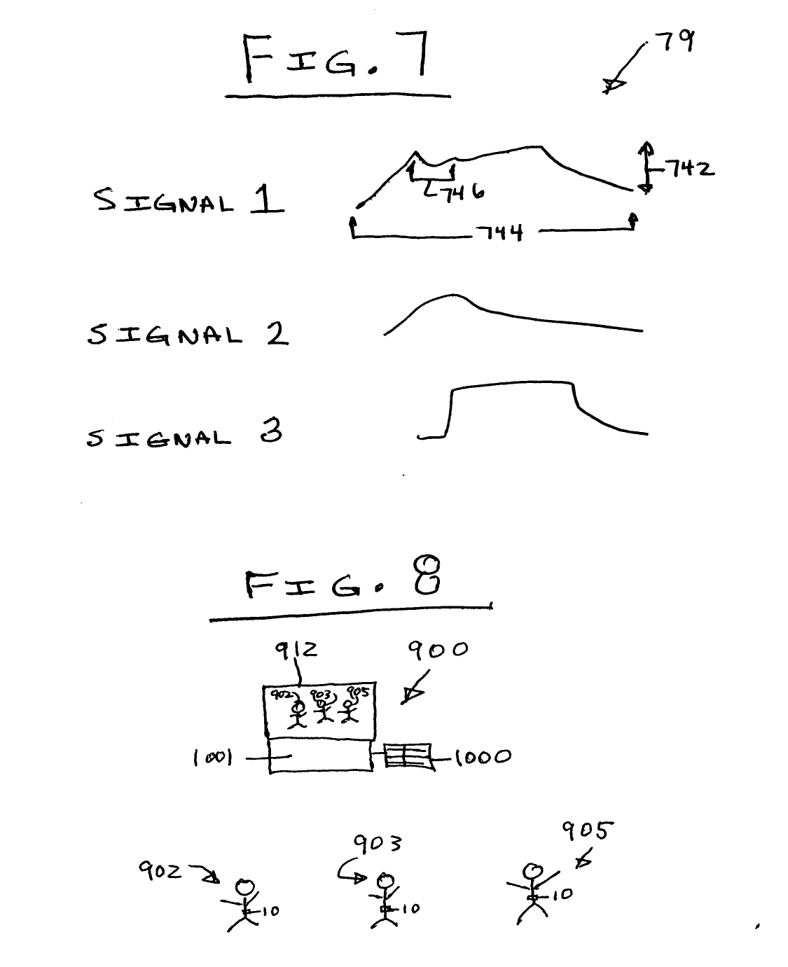

In yet another non-limiting embodiment of the invention, a digital signal processing type filter 520 is included and contained within the memory portion 102 and accessible and useable by the controller assembly 100 (by the use of bus 104). This filter 520 is used to examine each of the signals 79 which are received by the assembly 10 (and ultimately the controller assembly 100). That is, as is best perhaps shown in FIG. 7, the shape (e.g., highest amplitude 742, duration 744, and/or change in amplitude/frequency over a certain time frame 746) of a received signal 79 is different for different types of tangible entities and tangible entities of the same type have approximately similar types of signal shapes.

For example, “signal 1” of FIG. 7 may correspond to that of animal while “signal 2” of FIG. 7 may correspond to a vehicle. “Signal 3” of FIG. 7 may correspond to a human being. The signals of FIG. 7 are meant to represent acoustic type signals, although the analysis could equally be made for other types of signals.

Thus, the filter 520 may be used to determine the type of signal 79 that was or is being received and to selectively ignore cars or anything else but a human being or an animal. Alternatively, the filter 520 could be used to ignore whatever was desired and have controller assembly 10 provide an alarm type signal only when a certain type of signal (such as that associated with an animal or human being) was received (e.g., the “alarm type” signal may cause the vibrator 150 to be activated and/or the light assembly 350 and/or indicator 130 to be activated and/or to have the assembly 510 be activated and/or to have a SMS type message 504 generated). Other features of the received signal 79 may be used by the filter 520 to determine the identity of the sensed tangible entity.

In yet another non-limiting embodiment, (as is best perhaps shown in FIG. 8), one or more computer assemblies 900 may remotely and in real time interrogate a plurality of users 902,903, 905, each having a respective assembly 10. That is, the assembly 900, using the Internet, may automatically obtain the respective global positioning location of each user 902,903,905 and depict the various respective positions on a screen of display 912. The at least one computer assembly 900 may in one non-limiting embodiment, comprise a Hewlett Packard® Pavilion® lap top computer (having a keyboard 1000, display 912, and processing portion 1001), although other computers may be utilized. Thus, for example, if a plurality of border patrol agents 902,903,905, each wearing a respective assembly 10, are in a certain location (at a certain portion of the Arizona-Mexico border), the assembly 900 could find and display, in real time, the respective locations of each agent 902,903,905, thereby allowing a control command post to track the location and spatial movement of the various agents 902,903,905 (in “real time”) and dynamically update the respective locations. The assembly 10 (or just the portion 510) could also be placed on vehicles or any other asset, thereby making it relatively easy to track the location of their asset in “real time”. In yet another non-limiting embodiment, a map 940 of the general location in which assets 902,903,905, to be tracked are deployed (e.g., at a certain desert location) may be stored within the computer 900 and selectively displayed or placed on the screen 912. The respective asset locations may be placed on the map 912 thereby making it even easier for the certain command post to track the assets by visually showing the “real time” movement of the agents/assets 902, 903, 905 within the defined location/environment (i.e., within a square portion of the Arizona-Texas border having a length and a width of five miles).

What is claimed is:

1) A portable warning assembly comprising a first portion which senses the presence of a tangible entity; a second portion which automatically generates a message upon the sensed presence of said tangible entity; and a portion which allows the location of said assembly having a location and to be determined when said tangible entity is sensed.

2) A warning assembly comprising a controller assembly operating under stored program control; a memory portion which is coupled to said controller assembly and which includes a message and a cellular telephone number; a modem assembly which is coupled to said controller assembly; a global positioning portion which selectively transmits, said location of said warning assembly; and a signal generator which is coupled to said controller and which senses the presence of a tangible entity and which communicates said sensed presence of said tangible entity to said controller assembly, whereby said controller assembly retrieves said message and said telephone number and which then activates said modem effective to cause said message to be sent to a telephone having said telephone number and wherein said controller assembly then further activates said global positioning portion effective to allow said global positioning to transmit said location of said warning assembly.

3) A method for determining the location of assets, said method comprising the steps of placing a global positioning locator upon each asset; obtaining and displaying a map of the environment in which said assets are deployed; remotely interrogating each of said respective global positioning locators, effective to obtain the respective location of each assets; and displaying upon said map, the respective locations of each of said assets.
